(19) United States
(12) Patent Application Publication
(10) Pub. No.: US 2012/0052241 A1
(43) Pub. Date: Mar. 1, 2012

(54) Flexible Microstructured Superhydrophobic Materials

(75) Inventors: William P. King, Champaign, IL (US); Andrew H. Cannon, Columbia, SC (US)

(73) Assignee: THE BOARD OF TRUSTEES OF THE UNIVERSITY OF ILLINOI S, Urbana, IL (US)

(21) Appl. No.: 13/201,409

(22) PCT Filed: May 8, 2009
(86) PCT No.: PCT/US2009/043307

§ 371 Date: Nov. 18, 2011

Related U.S. Application Data
(60) Provisional application No. 61/153,035, filed on Feb. 17, 2009.
(60) Provisional application No. 61/153,028, filed on Feb. 17, 2009.
(60) Provisional application No. 61/162,762, filed on Mar. 24, 2009.

(51) Int. Cl. B32B 3/00; B29C 59/02

(52) U.S. Cl. 428/141; 264/293

(57) ABSTRACT

Described herein are flexible superhydrophobic films. Also described are methods for imparting superhydrophobicity to a variety of objects, for example objects having any shape or surface contours. For specific applications, the flexible superhydrophobic films include an adhesive backing layer, useful for attaching the film to objects. Some of the films described herein allow for selective control over the wettability of a surface by flexing the film, for example flexing the film results in a more wettable film, a less wettable film or a film having unchanged wettability. Flexible superhydrophobic films described herein also include films which maintain their superhydrophobicity when deformed into a concave or convex curvature.

### CROSS REFERENCE TO RELATED APPLICATION

This application claims the benefit of and priority to U.S. Provisional Application 61/153,028 filed on Feb. 17, 2009, U.S. Provisional Application 61/153,035 filed on Feb. 17, 2009, and U.S. Provisional Application 61/162,762 filed on Mar. 24, 2009, which are hereby incorporated by reference in their entireties.

### BACKGROUND OF THE INVENTION

This invention is in the field of superhydrophobic materials. This invention relates generally to flexible superhydrophobic films and flexible objects with superhydrophobic surfaces.

The roughness of a material changes how that material interacts with liquids. FIG. 1 shows a micrograph image of the surface of the lotus plant which uses micro and nanoscale roughness to change a water droplet's shape and behavior on the surface of the plant (W. Barthlott and C. Neinhuis, 1997, “Purity of the sacred lotus, or escape from contamination in biological surfaces,” Planta. 202: p. 1-8). The surface of the lotus plant exhibits superhydrophobicity, where water droplets do not significantly wet the surface and easily roll off the surface. These properties allow the surface of the lotus plant to be self-cleaning; that is, the water droplets which roll freely on the surface attract and pick up dirt, dust and other debris. When the droplets fall from the surface, they carry the debris away.

A number of patents and patent application publication disclose biomimetic surfaces which employ features similar to the surface of the lotus plant. For example, U.S. Pat. No. 7,175,723 discloses a curved surface for adhering to contact surfaces. The curved surface features a plurality of nano fibers having diameters and lengths between 50 nm and 2.0 μm.

U.S. Patent Application Publication US 2005/0181195 discloses superhydrophobic surfaces having a plurality of nanofibers between 1 nm and 200 μm in length.

U.S. Patent Application Publication US 2006/0078724 discloses a roughened surface structure having superhydrophobic properties. The roughened surface includes a plurality of asperites having a maximum height of about 100 μm.

U.S. Patent Application Publication US 2006/0097361 discloses a bisected honeycomb-patterned hydrophobic polymer structure. Upon bisection, a number of micropillar elements remain on the surface and have lengths between 0.1 and 50 μm with tip lengths between 0.01 and 20 μm. U.S. Patent Application Publication US 2007/0160790 also discloses liquid-repellent honeycomb-patterned, fibrous and needle-like patterned films.

U.S. Patent Application Publication US 2007/0231542 discloses a transparent, superhydrophobic surface having a plurality of features between 1 and 500 μm in height.

U.S. Patent Application Publication US 2007/0259156 discloses a superhydrophobic conduit lining having raised microscale features having lengths of less than 10 mm.

U.S. Patent Application Publication US 2008/0213853 discloses a magnetofluidic device having a superhydrophobic micropatterned polymer film having micro or nanoscale surface concavities or nanoscale structures such as nanodots and nanowires having diameters between 1 nm and 100 μm.

International Patent Application Publication WO 2008/035917 discloses formation of a superhydrophobic surface lined fluid transfer tube comprising a non-wetting fluoro-polymer material having a plurality of nanometer scale protrusions.

U.S. Patent Application Publication US 2009/0011222 discloses a stable superhydrophobic surface which maintains a contact angle of greater than 150 degrees after aging more than 1000 hours. The disclosed surface includes at least two particle sizes to form the hydrophobic surface.

### SUMMARY OF THE INVENTION

Described herein are flexible microstructured films, surfaces and systems, and related methods of making and using microstructured films, surfaces and systems. Also described are methods for imparting superhydrophobicity to a variety of objects, for example objects having any shape or surface contours. For specific applications, the flexible microstructured films include an adhesive backing layer, useful for attaching the film to objects. Some of the surfaces described herein allow for selective control over the wettability of the surface by flexing, for example flexing the surface results in a more wettable surface, a less wettable surface or a surface having unchanged wettability. Flexible microstructured films and surfaces described herein also include films and surfaces which maintain their superhydrophobicity when deformed into a concave or convex curvature.

In an embodiment, a flexible microstructured surface comprises a flexible substrate having a plurality of microfeatures disposed thereon. In a specific embodiment, the flexible microstructured surface maintains superhydrophobicity when the flexible substrate is deformed; for example, deformation resulting in convex and/or concave curvatures. In one embodiment, the flexible microstructured surface has more than two surfaces and microfeatures are disposed on two or more of those surfaces. In an embodiment, the flexible microstructured surface has one or more curved surfaces, such as one or more curved surfaces having the plurality of microfeatures disposed thereon. In some embodiments, the flexible substrate is in a selected deformed state, such as a flexed configuration, bent configuration, compressed configuration, expanded configuration and/or stretched configuration. Also provided herein are superhydrophobic materials wherein the degree of wettability, hydrophobicity and/or hydrophilicity of the surface is controllable by flexing, bending, expanding, stretching or compressing the flexible substrate having the plurality of microfeatures.

In some embodiments, a flexible microstructured surface is a freestanding film; that is, a film that is not attached to another object or structure. In embodiments, a flexible microstructured film comprises a roll of film. In embodiments, the flexible microstructured film further comprises an adhesive layer provided on a surface of the flexible substrate. In an embodiment, for example, the film further comprises an adhesive layer provided on a surface of the film disposed opposite to a surface having microfeatures. In an embodiment, the film comprises microstructures disposed on both sides of the film. Such a film optionally includes a backing layer, for example to protect the adhesive layer before use. Flexible microstructured film having an adhesive layer is useful, for example for attaching or otherwise integrating the film to one or more surfaces of an object or structure. Useful adhesive layers include those layers positioned on the side of the flexible substrate opposite to the microfeatures and are capable of attaching or otherwise integrating the microstructured film onto, or into, an object or structure in a manner that does not substantially affect the physical dimensions and/or mechanical properties of the microfeatures.

In specific embodiments, at least a portion of the substrate is in a bent, flexed, compressed, stretched, expanded, strained and/or deformed configuration. In one embodiment, at least a portion of the substrate has a radius of curvature selected over the range of 1 mm to 1,000 m. In an embodiment, at least a portion of the substrate is compressed to a level between 1% and 100% of an original size of the substrate. In an embodiment, at least a portion of the substrate is expanded or stretched to a level between 100% and 500% of an original size of the substrate. In an embodiment, at least a portion of the substrate has a strain level selected over the range of −99% to 500%.

Also described herein are objects, such as articles of manufacture, having microstructured surfaces. In one embodiment, an article of manufacture comprises a plurality of microfeatures on the surface of the article. In embodiments, an article of manufacture is useful as a stand alone object. In other embodiments, an article of manufacture is integrated into or onto one or more surfaces to impart superhydrophobicity to the one or more surfaces. Specific articles of manufacture include molded and/or cast objects such as metal objects, polymeric objects, rubber objects and edible objects. In specific embodiments, an article of manufacture comprises a flexible microstructured surface, such as described above. For example, in one embodiment, an article of manufacture comprises a sheet of metal having a superhydrophobic surface, preferably a surface having a plurality of microfeatures disposed thereon.

For some embodiments, the flexible substrate has a curved surface, for example a surface conforming to the contours of an object or structure. In an embodiment, for example, the surface of the flexible substrate having microfeatures disposed thereon is a curved surface, such as a surface having one or more concave and/or convex regions. In an embodiment, for example, a surface of the flexible substrate disposed opposite to the surface having microfeatures, and optionally having an adhesive layer, is a curved surface, such as a surface having one or more concave and/or convex regions. In other embodiments, the flexible substrate is substantially planar. In yet other embodiments, the flexible substrate includes surfaces having a combination of substantially planar regions and curved regions. In some embodiments the microstructured surface includes creases, folds or otherwise inelastically deformed regions, that are configured to allow a microstructured surface to conform to objects having corners or to adopt a deformed shape.

In some embodiments, the microstructured surface is operationally coupled to a structure, such as a backing layer or the surface of an object to which the microstructured surface is applied, capable of maintaining a substantially constant extent and/or degree of curvature of the microstructured surface. In some embodiments, the microstructured surface is operationally coupled to a structure, such as an actuator, capable of establishing, varying and/or controlling the extent and/or degree of curvature of the film. In some embodiments, the microstructured surface comprises the structure or surface of an object and is permitted to flex or deform during the normal operation or use of the object.

In an embodiment, the microfeatures and the flexible substrate comprise a unitary body, such as a monolithic structure having the microfeatures as an integral component of the substrate. In an embodiment, for example, the invention provides a flexible microstructured film wherein the microfeatures are an integrally formed part of the substrate itself, extending from the surface of the substrate, and optionally having the same composition as the substrate. In some embodiments, the microfeatures and the flexible substrate comprise an integral component of an object, such as an article of manufacture. The invention includes, for example, objects, including articles of manufacture, having the microfeatures and the flexible substrate provided as a component of a monolithic structure.

In a specific embodiment, the microfeatures have dimensions selected over the range of 10 nm to 1000 μm. In an embodiment, for example, the microfeatures have a length, height, diameter, and/or width selected over the range of 10 nm to 1000 μm, preferably for some embodiments selected over the range of 10 nm to 100 μm. In an embodiment, for example, a pitch between microfeatures is selected over the range of 10 nm to 1000 μm, for some applications selected over the range of 1 μm to 1000 μm, and for some applications selected over the range of 10 μm to 1000 μm.

In a specific embodiment, the plurality of microfeatures has a multimodal distribution of physical dimensions, for example a bimodal distribution of heights and/or a bimodal distribution of diameters and/or a bimodal distribution of microstructure pitch. In an exemplary embodiment, the plurality of microfeatures comprises a first set of microfeatures having a first set of dimensions and a second set of microfeatures having a second set of dimensions. In an embodiment, the first and second sets of dimensions are different. For example, the first set of dimensions is selected over the range of 10 nm to 10 μm and the second set of dimensions is selected over the range of 10 μm to 1000 μm.

Microfeatures useful on the flexible superhydrophobic films described herein include microfeatures having any cross sectional shape, for example cross sectional shapes including circles, ellipses, triangles, squares, rectangles, polygons, stars, hexagons, letters, numbers, mathematical symbols and any combination of these. Cross sectional shape, as used herein, describes the shape of a cross section of a microstructure in a plane parallel to the plane of the flexible substrate.

In embodiments, a flexible superhydrophobic surface comprises microfeatures having a preselected pattern. In an exemplary embodiment, the preselected pattern is a regular array of microfeatures. In another embodiment, the preselected pattern includes regions where the microfeatures have a first pitch and regions where the microfeatures have a second pitch, for example greater than the first pitch.

In one embodiment, a preselected pattern of microfeatures includes a region of microfeatures having a first cross sectional shape and a region of microfeatures having a second cross sectional shape, for example different from the first cross sectional shape. In one embodiment, a preselected pattern of microfeatures includes a region of microfeatures having multiple cross sectional shapes and/or sizes. In an embodiment, a preselected pattern of microfeatures refers to two or more arrays of microfeatures of two or more cross-sectional shapes and/or sizes. In a specific embodiment, the two or more arrays are positioned side by side; that is, where the two arrays do not overlap. In another specific embodiment, the two or more arrays are positioned to overlap, and microfeatures having the two or more cross sectional shapes and/or sizes are interspersed within the overlapping arrays.

In an embodiment, a preselected pattern of microfeatures includes multiple dimensions of microfeatures, for example a bimodal or multimodal distribution of dimensions. In an exemplary embodiment, a preselected pattern of microfeatures includes a first group of microfeatures having dimensions selected from 10 nm to 1 μm and a second group of microfeatures having dimensions selected from 1 μm to 100 μm. In a specific embodiment, the sizes, shapes and positions of the microfeatures are preselected with micrometer-scale or nanometer-scale accuracy and/or precision.

In certain embodiments, the flexible substrate and/or microfeatures comprise particles having dimensions selected over the range of 1 to 100 nm. In one embodiment, a coating is provided to a surface of the flexible substrate and/or microfeatures, for example a coating comprising particles having dimensions selected over the range of 1 to 100 nm. In embodiments, these particles provide an additional level of roughness on the nm scale to the surface of the flexible substrate and for certain embodiments increase the hydrophobicity of the surface and/or change the surface energy.

In some embodiment, the preselected pattern of microfeatures is engineered to impart specific physical characteristics to a surface. For example, an ordered array of microfeatures can impart superhydrophobicity to the surface of an object. Physical characteristics which can be adjusted and imparted by a preselected pattern of microfeatures include, but are not limited to: hydrophobicity, hydrophilicity, self-cleaning ability; hydro and/or aerodynamic drag coefficients; optical effects such as prismatic effects, specific colors and directional dependent color changes; tactile effects; grip; and surface friction coefficients.

For some embodiments, the wettability, hydrophobicity and/or hydrophilicity of the surface is controllable. For one embodiment, the wettability, hydrophobicity and/or hydrophilicity of the surface changes as the flexible substrate is deformed, for example by flexing, bending, expanding or contracting the substrate. For another embodiment, the wettability, hydrophobicity and/or hydrophilicity of the surface remains constant as the flexible substrate is deformed. For yet another embodiment, the wettability, hydrophobicity and/or hydrophilicity of the surface remains constant for some portions of the surface and the wettability of the surface changes for other portions of the surface as the flexible substrate is deformed. In a specific embodiment, a contact angle of a water droplet on the surface changes as the flexible substrate is deformed. In a specific embodiment, a contact angle of a water droplet on the surface remains constant as the flexible substrate is deformed.

In specific embodiments, a contact angle of a water droplet on the microstructured surface is greater than 120 degrees, for example greater than 130, 140, 150, 160 or 170 degrees.

In an embodiment, the microstructured surface, including the substrate and/or microfeatures disposed thereon, comprises a polymer. Useful polymers include, but are not limited to: PDMS, PMMA, PTFE, polyurethanes, Teflon, polyacrylates, polyarylates, thermoplastics, thermoplastic elastomers, fluoropolymers, biodegradable polymers, polycarbonates, polyethylenes, polyimides, polystyrenes, polyvinyls, polyoelefins, silicones, natural rubbers, synthetic rubbers and any combination of these.

In an embodiment, the microstructured surface, including the substrate and/or microfeatures disposed thereon, comprises a metal. Useful metals include any moldable, castable, embossable and/or stampable metal or alloy. Useful metals include, but are not limited to: aluminum, aluminum alloys, bismuth, bismuth alloys, tin, tin alloys, lead, lead alloys, titanium, titanium alloys, iron, iron alloys, indium, indium alloys, gold, gold alloys, silver, silver alloys, copper, copper alloys, brass, nickel, nickel alloys, platinum, platinum alloys, palladium, palladium alloys, zinc, zinc alloys, cadmium and cadmium alloys.

In embodiments, the microstructured surface is edible. For example, the microstructured surface, including the substrate and/or microfeatures disposed thereon, can comprise food and/or candy. Candy, as used herein, includes edible objects comprising a sugar or a sugar substitute as known in the art of food science. Food, as used herein, includes objects intended for human or animal consumption and includes edible polymeric materials and other edible materials known in the art of food science.

In some embodiments, the microstructured surface, including the substrate and/or microfeatures disposed thereon, comprises an industrial material derived from animals and/or plants, for example a material comprising carbohydrates, cellulose, lignin, sugars, proteins, fibers, biopolymers and/or starches. Exemplary plant and/or animal derived industrial materials include, but are not limited to: paper; cardboard; textiles, such as wool, linen, cotton or leather; bioplastics; solid biofuels or biomass, such as sawdust, flour or charcoal; and construction materials, such as wood, fiberboard, linoleum, cork, bamboo and hardwood.

In certain embodiments, the microstructured surface comprises a composite material. For example, the microstructured surface, including the substrate and/or microfeatures disposed thereon, can comprise two or more distinct materials, layers and/or components.

In an embodiment, the microstructured surface comprises a coating on and/or over the plurality of microstructures. Useful coatings include, but are not limited to: fluorinated polymers, fluorinated hydrocarbons, silanes, thiols, and any combination of these. In various embodiments, the microstructured surface undergoes a step of processing the surface. Useful surface processing methods include, but are not limited to curing, cooking, annealing, chemical processing, chemical coating, painting, coating, plasma processing and any combination of these.

In a specific embodiment, the microfeatures of the microstructured surface are replicated from a lithographically patterned mold. In one embodiment, the microfeatures are directly replicated from a lithographically patterned mold (first generation replication). In another embodiment, the microfeatures are replicated from a mold having microfeatures replicated from a lithographically patterned mold (second generation replication). In another embodiment, the microfeatures are third or subsequent generation replicated features of a lithographically patterned master.

In another aspect, methods are provided for controlling the hydrophobicity and/or wettability of a surface comprising a flexible substrate having a plurality of microfeatures disposed thereon. A method of this aspect comprises the steps of: (i) providing the flexible substrate having a plurality of microfeatures disposed thereon; and (ii) deforming the flexible substrate thereby controlling the superhydrophobicity of the surface. In an embodiment, the surface is a superhydrophobic surface, for example any of the superhydrophobic surfaces described herein. In an embodiment, deforming the flexible substrate is achieved by flexing the flexible substrate, bending the flexible substrate, expanding the flexible substrate, stretching the flexible substrate and/or compressing the flexible substrate. In an embodiment, deforming the flexible substrate selectively varies the pitch between at least a portion of the microfeatures, for example by increasing or decreasing the pitch by a value selected over the range of 10 nm to 1000 μm, and optionally a value selected over the range of 100 nm to 100 μm.

In embodiments, one or more physical, mechanical or optical properties, other than and/or in addition to hydrophobicity, are established, varied and/or controlled by deforming a flexible substrate having a plurality of microfeatures disposed thereon. In an embodiment, for example, an optical property, such as the reflectivity, wavelength distribution of reflected or scattered light, transparency, wavelength distribution of transmitted light, refractive index or any combination of these, is controlled by flexing, bending, expanding, stretching and/or contracting the flexible substrate having a plurality of microfeatures disposed thereon. In an embodiment, a physical property, such as aerodynamic resistance or hydrodynamic resistance is controlled by flexing, bending, expanding, stretching and/or contracting the flexible substrate having a plurality of microfeatures disposed thereon. In an embodiment, a tactile property of the surface, such as the surface's tactile sensation, is controlled by flexing, bending, expanding, stretching and/or contracting the flexible substrate having a plurality of microfeatures disposed thereon.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a scanning electron microscope image of the surface of a lotus leaf (W. Barthlott and C. Neinhuis, 1997, “Purity of the sacred lotus, or escape from contamination in biological surfaces,” Planta. 202: p. 1-8).

FIG. 2 provides an illustration of an exemplary flexible superhydrophobic surface comprising a flexible substrate and a plurality of microfeatures.

FIG. 3 provides a flow diagram of an exemplary method embodiment for making a flexible superhydrophobic surface.

FIG. 4 provides an illustration of a surface roughened by microfabrication techniques showing a change in a contact angle of a liquid droplet on the surface.

FIG. 5 provides illustrations of liquid droplets on a surface in Wenzel and Cassie-Baxter states.

FIG. 6 provides images of a water droplet on a nonmicrostructured surface and on a microstructured surface.

FIG. 7 provides illustrations and an image of a convexly curved microstructured surface and a liquid droplet on a convexly curved microstructured surface.

FIG. 8 provides illustrations and an image of a concavely curved microstructured surface and a liquid droplet on a concavely curved microstructured surface.

FIG. 9 provides illustrations of liquid droplets on nonmicrostructured and microstructured surfaces.

FIG. 10 provides illustrations showing a change in microfeature pitch for convex and concave surfaces.

FIG. 11 provides images showing the change in pitch of silicone micropillars: A) Flat PDMS micropillars with spacing of 24.4 μm in the direction of flexure. B)+0.11/mm curvature increased pillar spacing from 24.4 μm to 26.2 μm in the direction of flexure (predicted=25.5 μm). C)−0.22/mm curvature decreased pillar spacing from 24.4 μm to 20.7 μm in the direction of flexure (predicted=22.1 μm).

FIG. 12 provides a model showing the critical curvature of a liquid droplet in the Cassie-Baxter state on a surface versus pitch for a variety of microfeature heights.

FIG. 13 shows images of a glycerol droplet on a nonmicrostructured and microstructured PDMS surface.

FIG. 14 shows images of liquid droplets of water and a 40/60 by weight mixture of glycerol/water on flexed superhydrophobic surfaces. The contact angles (CA) are noted and plotted versus curvature.

FIG. 15 provides data showing the tilt angle causing sliding for A) water and B) a 40/60 by weight mixture of glycerol/water droplets on a microstructured PDMS surface with various microstructure heights as a function of surface curvature.

FIG. 16 shows modeling results for pillars 5 μm in diameter with a pitch of 8 μm for a droplet with an original contact angle θ of 100°.

FIG. 17 shows modeling results for the transition between Cassie-Baxter and Wenzel states.

FIG. 18 shows images of cooled droplets of liquid metal provided to the surface of microstructured PDMS with various curvatures.

### DETAILED DESCRIPTION OF THE INVENTION

In general the terms and phrases used herein have their art-recognized meaning, which can be found by reference to standard texts, journal references and contexts known to those skilled in the art. The following definitions are provided to clarify their specific use in the context of the invention.

“Superhydrophobic” refers to a property of a material in which a liquid, for example water, does not significantly wet the surface of the material. In specific embodiments, superhydrophobic refers to materials which have a liquid contact angle greater than 120 degrees, for example greater than 130 degrees, greater than 140 degrees, greater than 150 degrees, greater than 160 degrees or greater than 170 degrees.

“Freestanding” refers to an object not attached to another object, for example a surface or substrate. In a specific embodiment, a freestanding film comprises multiple layers, for example a flexible polymer layer and an adhesive layer.

“Unitary”, “unitary body” and “monolithic” refer to objects or elements of a single body of the same material.

“Microfeatures” and “microstructures” refers to features, on the surface of an object, having an average width, depth, length and/or thickness of 100 μm or less or selected over the range of 10 nm to 100 μm.

“Preselected pattern” refers to an arrangement of objects in an organized, designed, or engineered fashion. For example, a preselected pattern of microstructures can refer to an ordered array of microstructures. In an embodiment, a preselected pattern is not a random and/or statistical pattern.

“Pitch” refers to a spacing between objects. Pitch can refer to the average spacing between a plurality of objects, the spacing between object centers and/or edges and/or the spacing between specific portions of objects, for example a tip, point and/or end of an object.

“Wettability” refers to the affinity of a surface for a liquid. “Hydrophilicity” refers to the degree of attraction of a surface for a liquid. “Hydrophobicity” refers to the degree of repulsion of a surface for a liquid. In some embodiments, the wettability, hydrophilicity and/or hydrophobicity of a surface is referred to with relation to the contact angle of a liquid on the surface. The terms “wettable”, “hydrophilic” and “liquid-philic” are used interchangeably herein to refer to liquid-surface contact angles less than 90 degrees. The terms “non-wettable”, “hydrophobic” and “liquid-phobic” are used interchangeably herein to refer to liquid-surface contact angles greater than 90 degrees. For some embodiments, the affinity of a surface is different for different liquids; in these embodiments a surface can be simultaneously liquid-phobic and liquid-philic, depending upon the liquid being referred to.

“Contact angle” refers to the angle at which a liquid-gas interface meets a solid.

“Flexible” refers to the ability of an object to deform in a reversible manner, such that the object does not undergo damage when deformed, such as damage characteristic of fracturing, breaking or inelastically deforming.

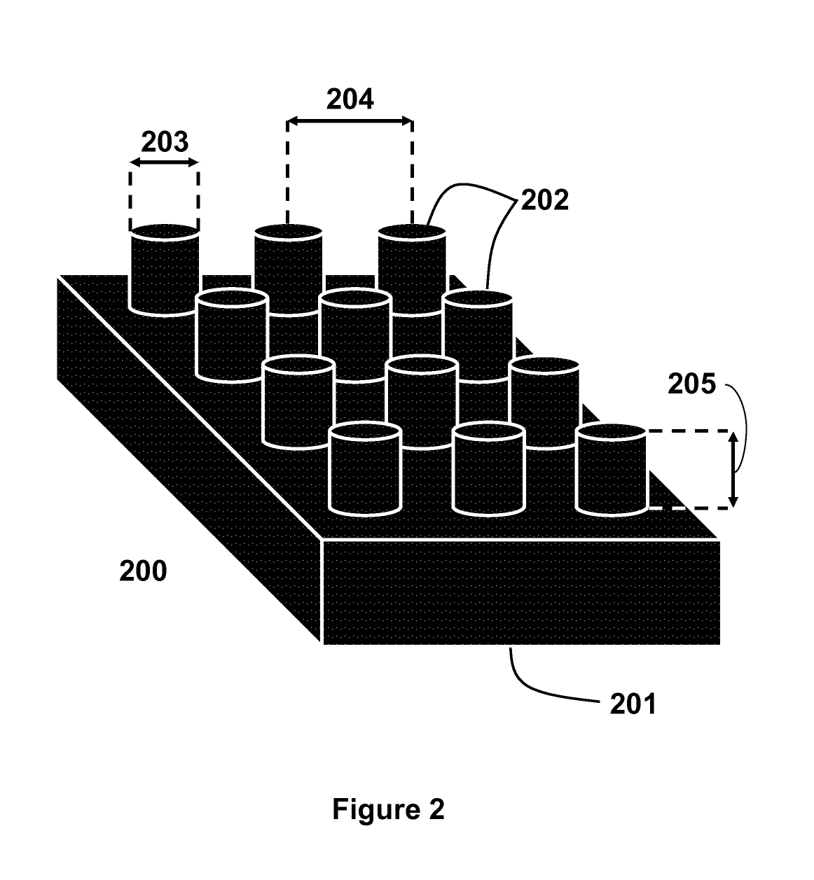

FIG. 2 shows a portion of an exemplary flexible superhydrophobic surface embodiment 200. The flexible superhydrophobic surface shown in FIG. 2 comprises a flexible substrate 201 and microfeatures 202. Microfeatures 202 of this embodiment have circular cross sectional shapes having a diameter 203. The pitch 204 between the center of microfeatures and microfeature height 205 are also shown in FIG. 2.

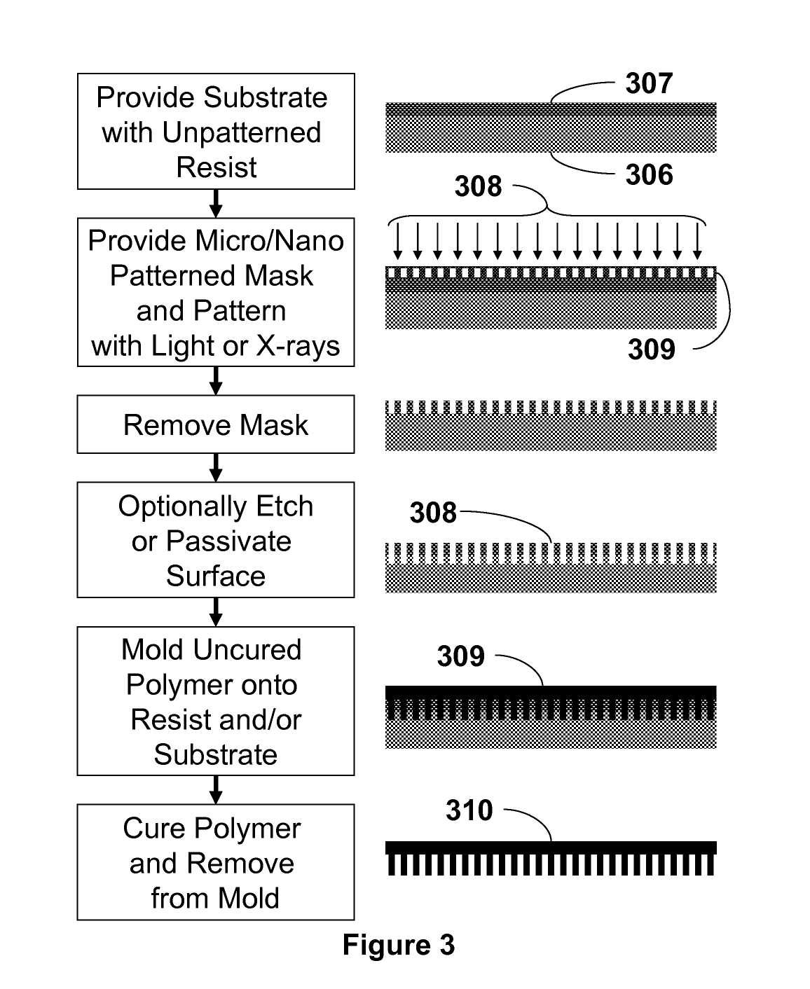

FIG. 3 shows one embodiment for making a flexible superhydrophobic surface. The technique begins with a substrate 306 topped with a photosensitive polymer or resist 307 sensitive to light or particles. By shining light 308 through a stencil mask 309 onto the resist 307, micrometer-scale or nanometer-scale structures can be formed in the resist. In other embodiments, other kinds of electromagnetic waves, energy beams, or particles are used to form these microfeatures or nanofeatures.

The resist 307 having tailored microfeature or nanofeature negatives 308 is used as a mold at this stage. The substrate can also be treated (for example with a chemical etch) to modify the microfeatures. For some embodiments, the surface is coated with an agent to ease or improve subsequent molding steps.

Uncured polymer 309 is molded into the microfeatures and cured by heat, time, UV light or other curing methods. When the cured polymer 310 is removed from the substrate-resist mold, the features from the mold are transferred into the polymer 309, and are also mechanically flexible.

In another aspect, provided herein are methods for controlling the superhydrophobicity of a surface. A method of this aspect comprises the steps of: providing a superhydrophobic surface; and deforming the superhydrophobic surface, thereby controlling the superhydrophobicity of the surface. In an embodiment of this aspect, the superhydrophobic surface comprises a flexible substrate having a plurality of microfeatures disposed thereon. In a specific embodiment, the flexible substrate comprises a polymer. In an embodiment, the flexible substrate comprises a metal.

In an embodiment, as the flexible substrate is deformed, the pitch between adjacent microfeatures is varied, thereby controlling the superhydrophobicity of the film. In some embodiments, properties of the microstructured surface are selectively adjusted by bending, flexing, compressing, stretching, expanding, straining and/or deforming the substrate. In specific embodiments, properties of at least a portion of the microstructured surface are selectively adjusted by bending, flexing, compressing, stretching, expanding, straining and/or deforming at least a portion of the substrate. For example, the aerodynamic and/or hydrodynamic resistance of the surface may be selectively adjusted by bending, flexing, compressing, stretching, expanding, straining and/or deforming the substrate. In one embodiment, the wettability of the surface is selectively adjusted by bending, flexing, compressing, stretching, expanding, straining and/or deforming the substrate. In an embodiment, an optical properties of the surface may be selectively adjusted by bending, flexing, compressing, stretching, expanding, straining and/or deforming the substrate. For example prismatic effects, directional dependent reflectivity, directional dependent transmission, reflectivity, transparency, distribution of reflected wavelengths, distribution of scatted wavelengths, distribution of transmitted wavelengths and/or index of refraction of the surface may be selectively adjusted by bending, flexing, compressing, stretching, expanding, straining and/or deforming the substrate

In another aspect, provided herein are methods for controlling the wettability of a surface. A method of this aspect comprises the steps of: providing a surface comprising a flexible substrate having a plurality of microfeatures disposed thereon; and deforming the flexible substrate, thereby controlling the wettability of the surface of the surface. In a specific embodiment, the flexible substrate comprises a polymer. In a specific method of this aspect, deforming the flexible substrate changes a pitch between adjacent microfeatures. Useful deformations include, but are not limited to: stretching the flexible substrate; forcing the flexible substrate to adopt a curved shape; and bending the flexible substrate. For some embodiments, the wettability of the surface increases upon deforming the flexible substrate. For some embodiments, the wettability of the surface decreases upon deforming the flexible substrate. For some embodiments, the wettability of the surface does not change upon deforming the flexible substrate.

In another aspect, provided herein are methods for making the surface of an object superhydrophobic. A method of this aspect comprises the steps of: providing the object; providing a microstructured surface comprising a polymer substrate having a plurality of microfeatures disposed thereon and an adhesive layer; and applying the microstructured surface to the surface of the object. In a specific embodiment, the adhesive layer on the polymer substrate attaches the microstructured surface to the object and/or is positioned on the opposite side of the flexible substrate as the plurality of microfeatures.

Methods described herein are useful for giving any object a microstructured surface, for example objects comprising one or more curved surfaces. In specific embodiments, useful objects provided with microstructured surfaces include, but are not limited to: aircraft wings; boats; utility line insulation; sporting goods, such as grips, baseball bats, golf clubs, footballs, basketballs; cooking utensils; kitchenware; bathroom items such as toilets, sinks, tiles, bath tubs, shower curtains; handheld controllers, such as for gaming or equipment operation; bottles; computer keyboards; computer mice; jewelry; shoes; belts; rain jackets; helmets; pipes, including both inner and outer surfaces; candles; glass jars and jar lids; food and candy; turbine blades; pump rotors; heat sinks; insignia; windows; hoses; coolers; wheels.

The invention may be further understood by the following non-limiting examples.

### EXAMPLE 1

### Flexible Micro and Nanostructured Superhydrophobic Materials

This example describes flexible material that is rendered superhydrophobic by micro and nanostructuring. The term superhydrophobic refers to the extreme water-repellent nature of materials. While some work has shown microstructured superhydrophobic material with no curvature and other work teaches the reader how to create rigid curved microstructured superhydrophobic materials, no work has combined flexibility with curvature and microstructured superhydrophobic material.

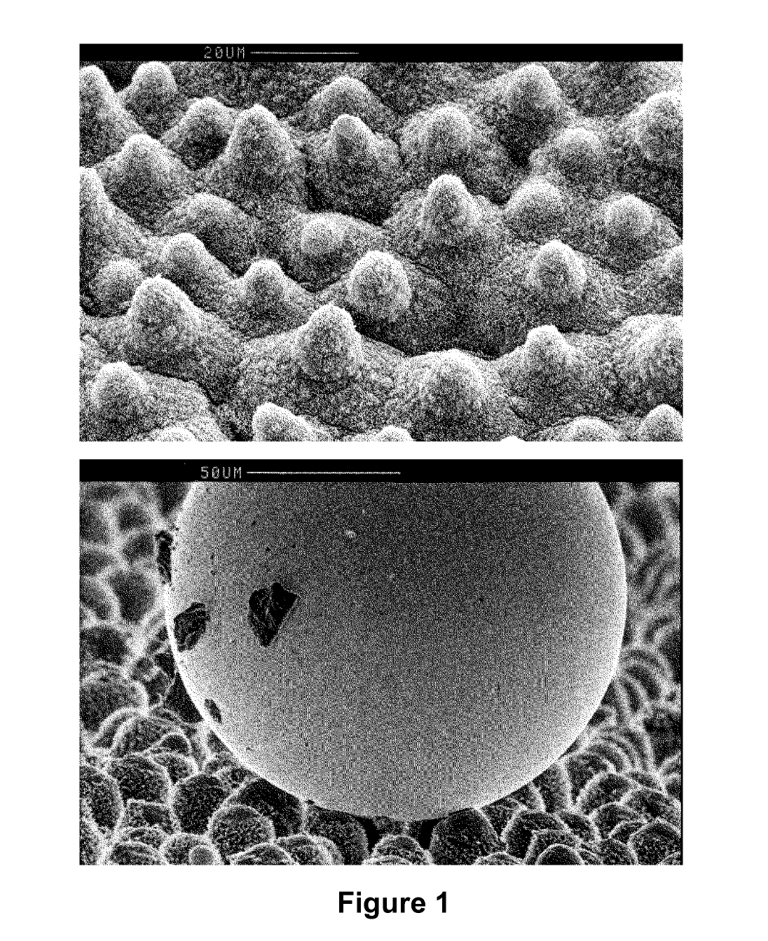

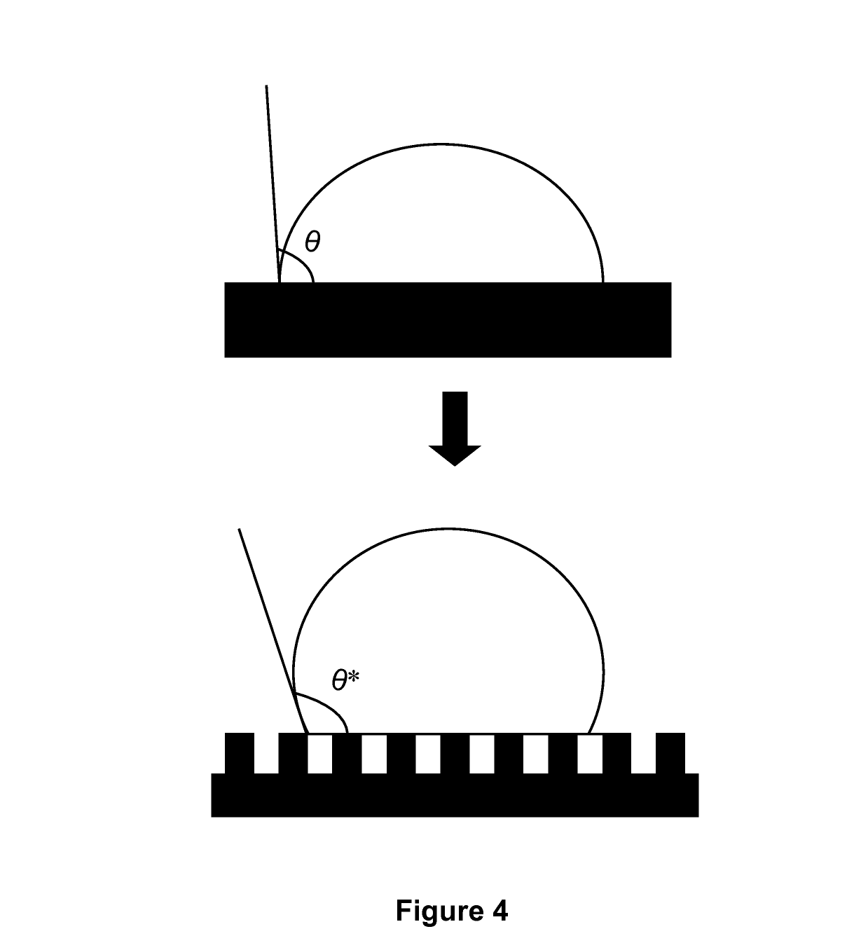

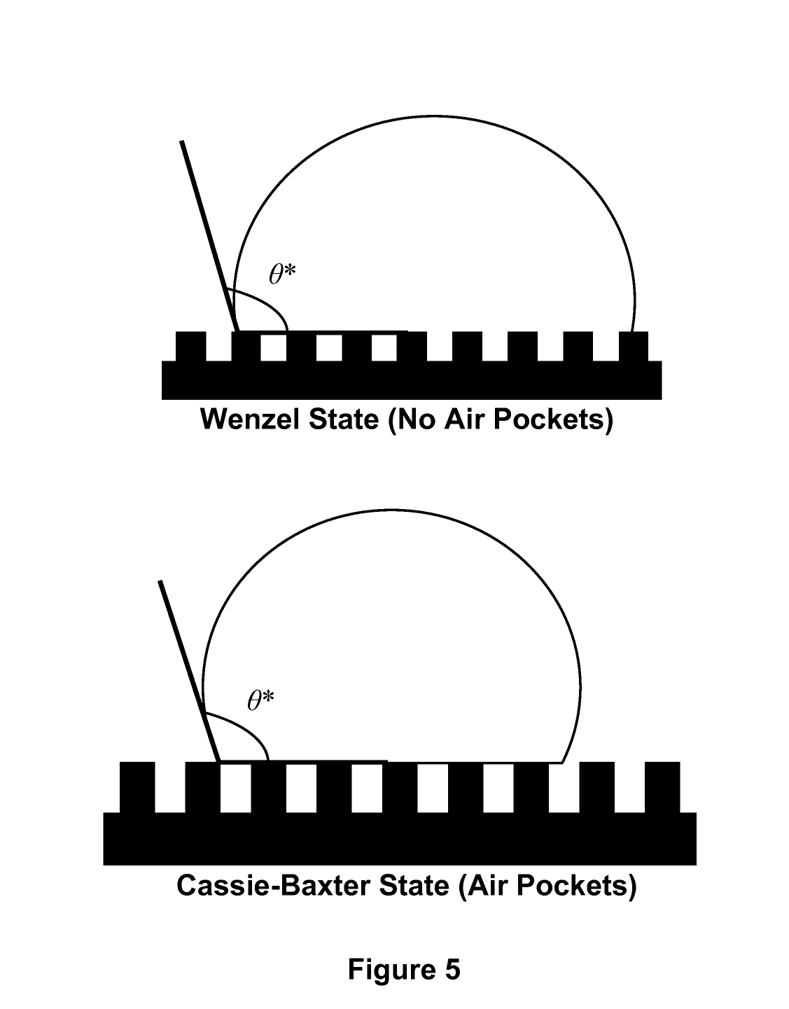

The roughness of a material changes how that material interacts with liquids. FIG. 1 shows a micrograph image of the surface of the lotus plant which uses micro and nanoscale roughness to change a water droplet's shape and behavior on the surface of the plant (W. Barthlott and C. Neinhuis, 1997, “Purity of the sacred lotus, or escape from contamination in biological surfaces,” Planta. 202: p. 1-8). The surface of the lotus plant exhibits superhydrophobicity, where water droplets do not significantly wet the surface and easily roll off this rough surface. Microfabrication tools can roughen materials on the micro and nanoscale, enhancing hydrophobicity in a similar manner as the lotus plant, illustrated by FIG. 4. Hydrophobic materials are those whose original contact angle θ is greater than 90°. If a material is hydrophobic then the new contact angle θ* of the roughened material will be larger than 90°. FIG. 5 illustrates two different wetting states possible on micro/nanostructured materials: the Wenzel state and the Cassie-Baxter state. In the Wenzel State water is in intimate contact with the solid in both the valleys and peaks. In the Cassie-Baxter state water touches only the peaks, leaving gas pockets between the liquid and the valleys. Droplets slide on Cassie-Baxter surfaces with less required force than for Wenzel surfaces. One can predict θ* and the wetting state for the micro/nanostructured material if the θ and surface geometry are known. The Wenzel equation and can be used to predict the new contact angle of a droplet on a micro or nanostructured material: cos θ*=r cos θ, where r is the ratio of actual surface area to the projected surface area, r=Area_{actual}/Area_{projected}. The Cassie-Baxter equation can also be used to predict θ*: cos θ*=−1+φ(cos θ+1), where Φ is the fraction of the area the water touches when a droplet is in the Cassie-Baxter state.

To determine whether a liquid is in the Wenzel or Cassie-Baxter state, one can calculate θ* with Wenzel's method and then with Cassie-Baxter's method. The two different methods will give two different predicted contact angles. The smallest contact angle calculated is most likely. If that contact angle was calculated using the Wenzel equation, the droplet is most likely in the Wenzel state. If that contact angle was calculated using the Cassie-Baxter equation, the droplet is most likely in the Cassie-Baxter state.

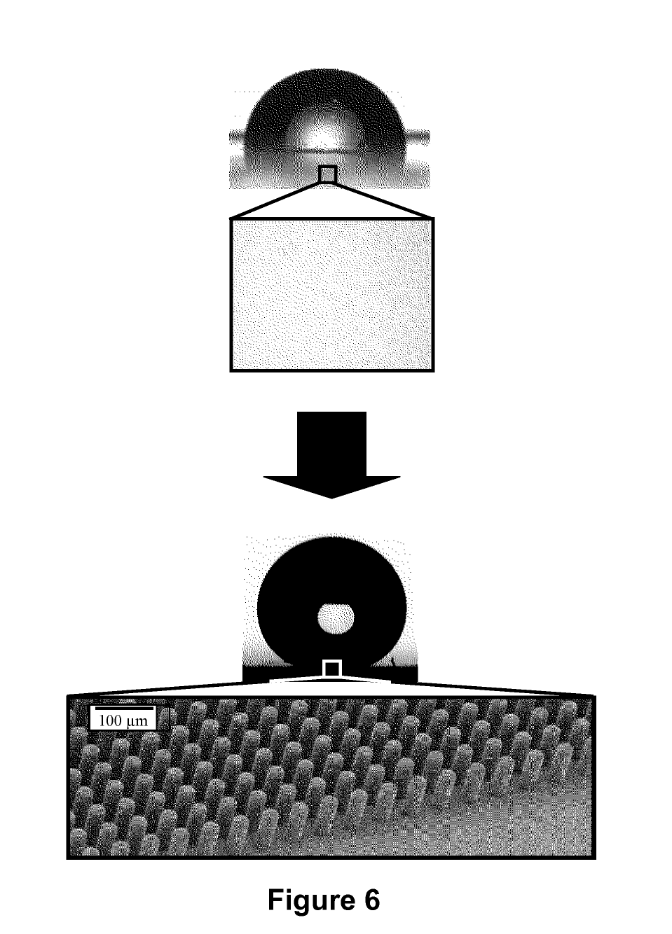

FIG. 6 shows pictures of flat, nonmicrostructured and microstructured material with water droplets applied. On the nonmicrostructured material, the θ of the droplet is 94°, indicating that the material is hydrophobic. When microstructures are formed in the hydrophobic material, its new contact angle increases to a θ* of 152°. The water droplet is in the Cassie-Baxter State.

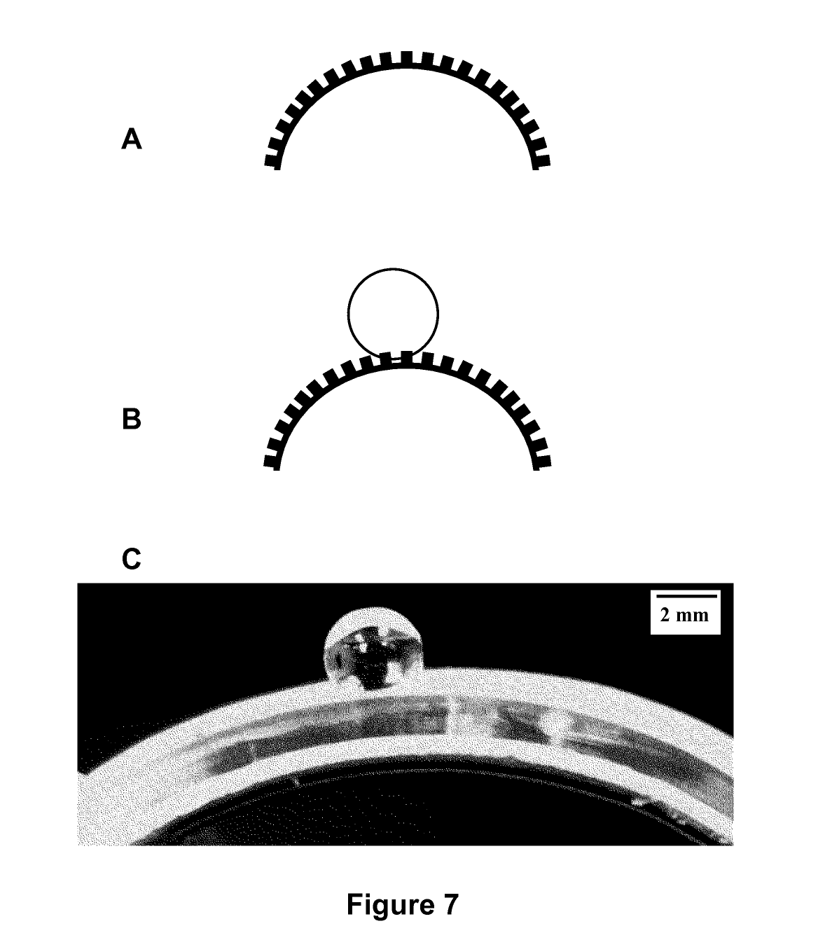

FIG. 7A illustrates that the microstructured material can flex into a convex shape; FIG. 7B illustrates that the convexly flexed microstructured material maintains its superhydrophobicity when a water droplet is applied; and FIG. 7C shows a picture of the same material from FIG. 6 flexed into a convex shape with a water droplet applied. The water droplet exhibits similar superhydrophobic characteristics shown on the bottom of FIG. 6. The superhydrophobicity of the material may change wetting states and θ* when it flexes convexly because the microstructures spread apart, increasing the effective pitch of the microstructures and decreasing the effective φ. The decrease in effective φ may lead to an increase in θ* and also a greater likelihood of being in the Wenzel state than when the microstructured material was not flexed.

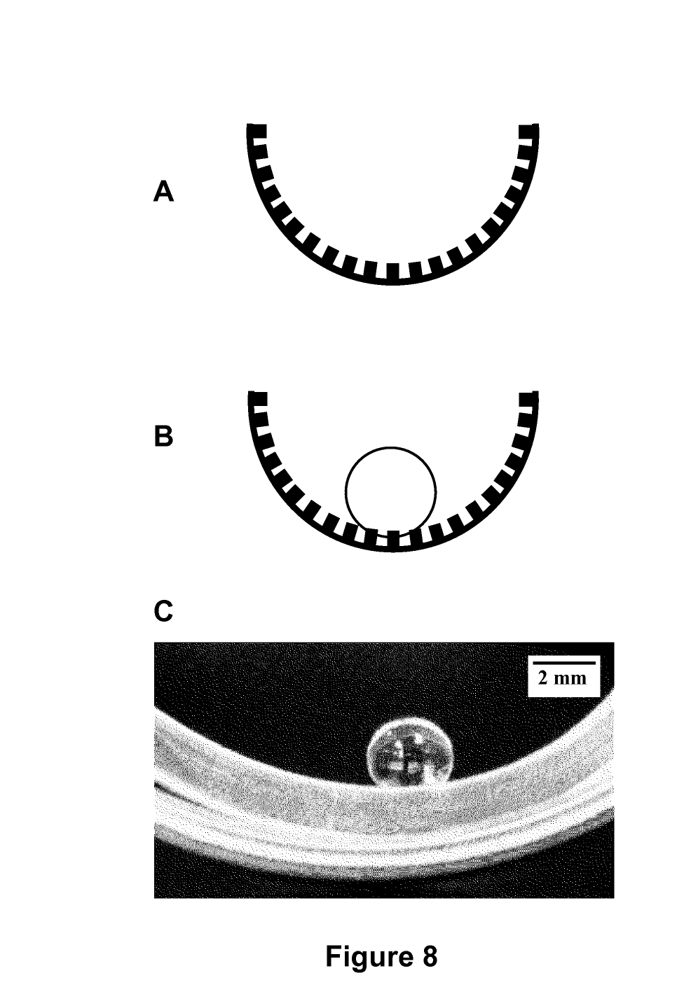

FIG. 8A illustrates that the microstructured material can flex into a concave shape; FIG. 8B illustrates that the concavely flexed microstructured material maintains its superhydrophobicity when a water droplet is applied; and FIG. 8C shows a picture of the same material from FIG. 6 flexed into a concave shape with a water droplet applied. The water droplet exhibits similar superhydrophobic characteristics shown on the bottom of FIG. 6. The superhydrophobicity of the material may change wetting states and θ* when it flexes concavely because the tops of the microstructures move closer together, decreasing the effective pitch of the microstructures and increasing the effective φ. The increase in effective φ may lead to a decrease in θ* and also a greater likelihood of being in the Cassie-Baxter state than when the microstructured material was not flexed.

Figure Captions:

FIG. 1. Scanning electron microscope image of the surface of a lotus leaf. Micro and nanoscale roughness changes a water droplet's shape and behavior on the surface. The friction between water and these surfaces is greatly reduced—water droplets roll easily off the surface.

FIG. 4. Standard microfabrication techniques can roughen materials on the micro and nanoscale. Material roughness alters how that material interacts with liquids.

FIG. 5. The Wenzel State and Cassie-Baxter State are both possible for a micro/nano-structured material. In the Wenzel State liquid is in intimate contact with the solid in both the valleys and peaks. In the Cassie-Baxter state liquid touches only the tops of the peaks.

FIG. 6. Pictures of water on nonmicrostructured and microstructured material. Top: Water droplet on nonmicrostructured material. Bottom: Water droplet on microstructured material. Microstructuring hydrophobic material makes the material more hydrophobic.

FIG. 7. The flexible microstructured material can be flexed into a convex shape. FIG. 7A. Flexible microstructured material flexed into a convex shape. FIG. 7B. Droplet on flexible microstructured material flexed into a convex shape. FIG. 7C. Picture of Droplet on flexible microstructured material flexed into a convex shape.

FIG. 8. The flexible microstructured material can be flexed into a concave shape. FIG. 8A. Flexible microstructured material can be flexed into a concave shape. FIG. 8B. Droplet on flexible microstructured material flexed into a concave shape. FIG. 8C. Picture of Concave Flexed Microstructured Superhydrophobic Material with Water Droplet.

### EXAMPLE 2

### Curvature Affects Superhydrophobicity on Flexible Silicone Microstructured Surfaces

Superhydrophobicity can inhibit corrosion, control fluid flow, and reduce surface drag. Surface microstructures can control the hydrophobicity of surfaces by modulating droplet-surface interactions. Published research on microstructured hydrophobic surfaces has been limited almost exclusively to flat surfaces, while the ability to fabricate microstructures on curved surfaces is required for many applications of superhydrophobicity. Microfabrication in polymers offers an inexpensive route for creating microstructured superhydrophobic surfaces, and polymer compliance permits curved microstructured hydrophobic surfaces. This example describes how curvature of a flexible microstructured polymer affects its hydrophobicity.

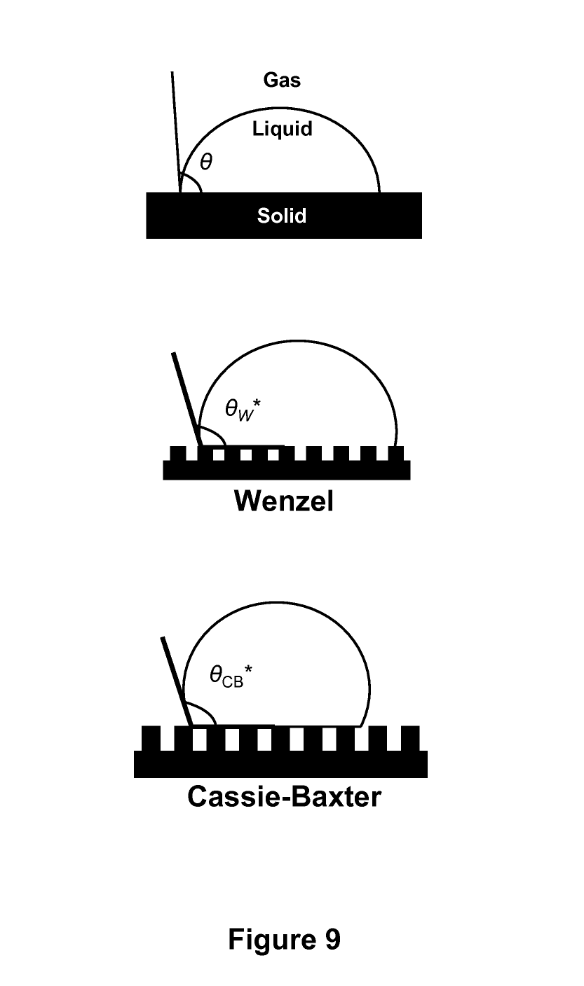

FIG. 9 shows the ways that a droplet with contact angle θ can interact with a hydrophobic surface: either in the Wenzel state θ_{w}, or in the Cassie-Baxter state θ_{CB}. It is desirable to achieve the Cassie-Baxter state because the droplets are significantly more mobile. The size, shape, and pitch of microstructures on a surface affect the droplet state on the surface in either state.

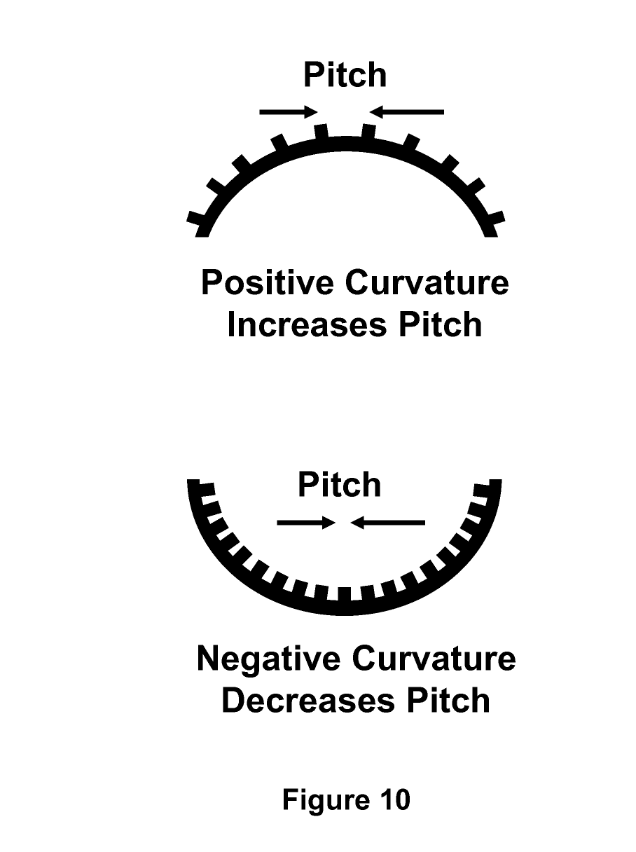

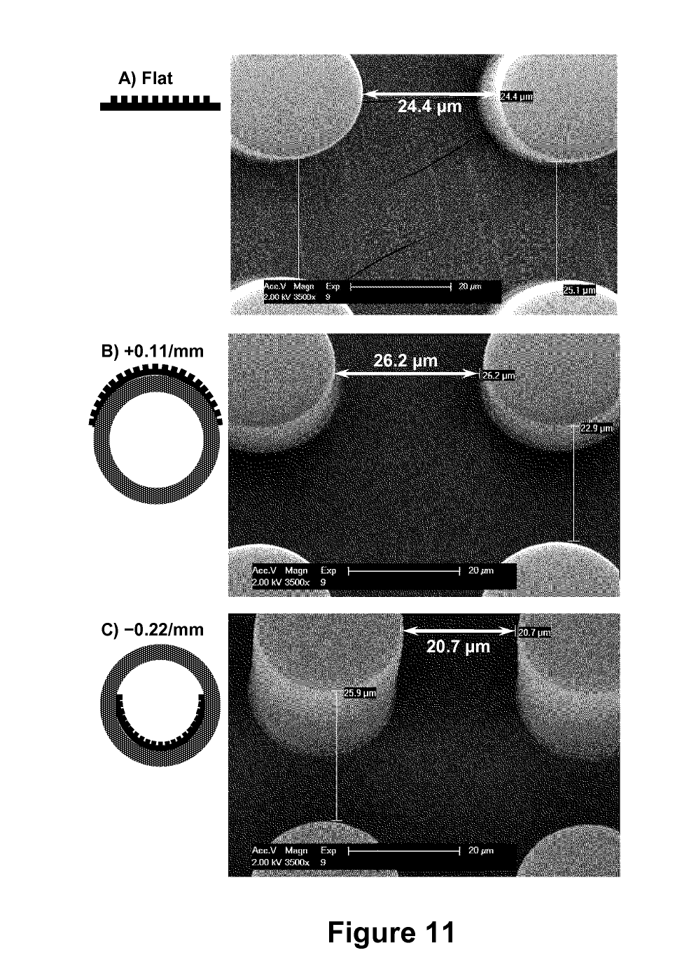

The flexing of a polymer can change the microstructure pitch, affecting the hydrophobicity. FIG. 10 shows that when a microstructured surface flexes, the microstructure-droplet interaction changes such that the apparent pitch changes as well. With positive curvature, the droplet interacts with fewer microstructures, and with negative curvature, the droplet interacts with more microstructures. θ_{CB} is therefore a function of curvature because the tops of the pillars affect the Cassie-Baxter state. Curvature thus affects hydrophobic properties such as the droplet sliding. FIG. 11 provides images showing the change in pitch of PDMS pillars as a function of curvature for pillars 25 μm in diameter and 70 μm in height. A) Flat PDMS micropillars with spacing of 24.4 μm. B) Positive Curvature of +0.11/mm increased Pillar spacing from 24.4 μm to 26.2 μm (predicted=25.5 μm). C) Negative Curvature of −0.22/mm decreased Pillar spacing from 24.4 μm to 20.7 μm (predicted=22.1 μm).

For the Cassie-Baxter state to exist, the inequality must be satisfied cos θ<(φ−1)/(r−φ), where φ is the area fraction of the pillar tops and r is the ratio of true surface area to projected surface area. The critical pitch for Wenzel/Cassie-Baxter transition is then

$${P}_{c} = \frac{A - \frac{hb cos θ}{1 + cos θ}}{P} ,$$

where A is the area of the microstructure top, h is microstructure height, b is microstructure perimeter, and P is microstructure pitch on a flat surface.

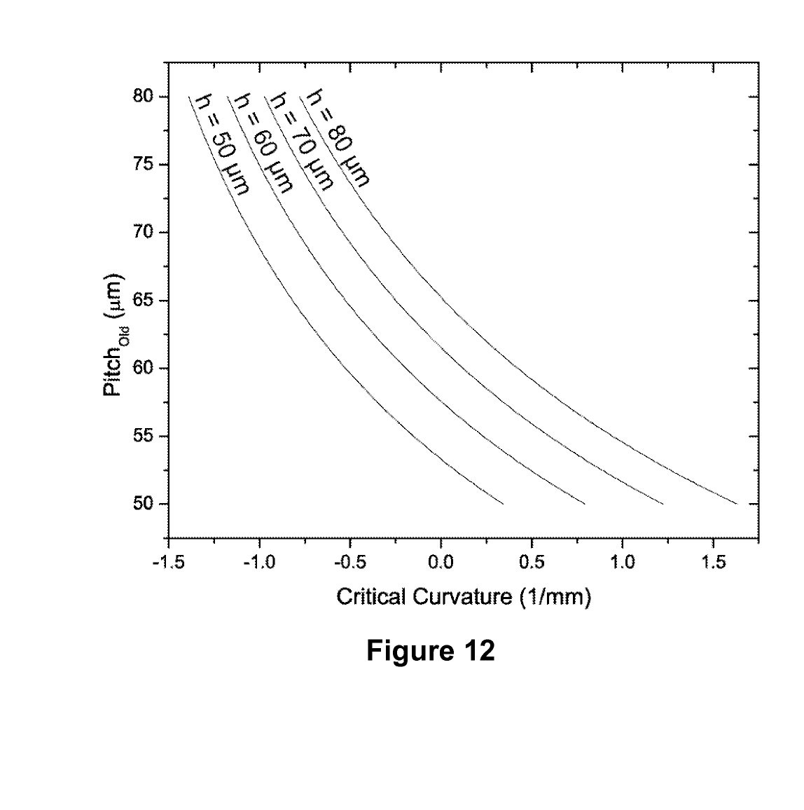

When a film of thickness t is flexed with radius of curvature R to the neutral axis of the film, the new pitch in the direction of flexure is P_{α}=P(R+t/2+h)·R⁻¹. FIG. 12 shows how critical surface curvature (1/R_{c}) varies with P for several values of microstructure height for microstructures with diameter=25 μm, thickness=0.7 mm and θ=112°.

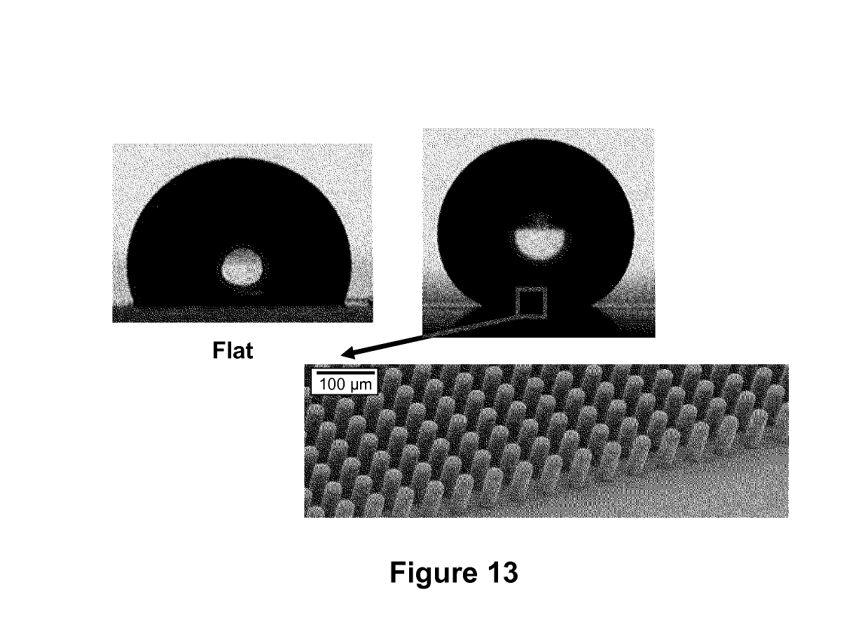

To experimentally test how flexure affects hydrophobicity of microstructured materials, polydimethylsiloxane (PDMS) sheets were prepared 0.7 mm thick with an array of 25 μm diameter pillars, 50 μm pitch, and 70 μm tall. Contact angle θ of 10 μl of deionized water and a 40/60 wt. mixture of Glycerol/water on flat PDMS was 102° and 112°. θ_{CB} of 10 μl of water and Glycerol/water on flat microstructured PDMS was 147° and 152°. FIG. 13 shows the contact angle for Glycerol/water increases when placed on the microstructured PDMS compared to flat PDMS.

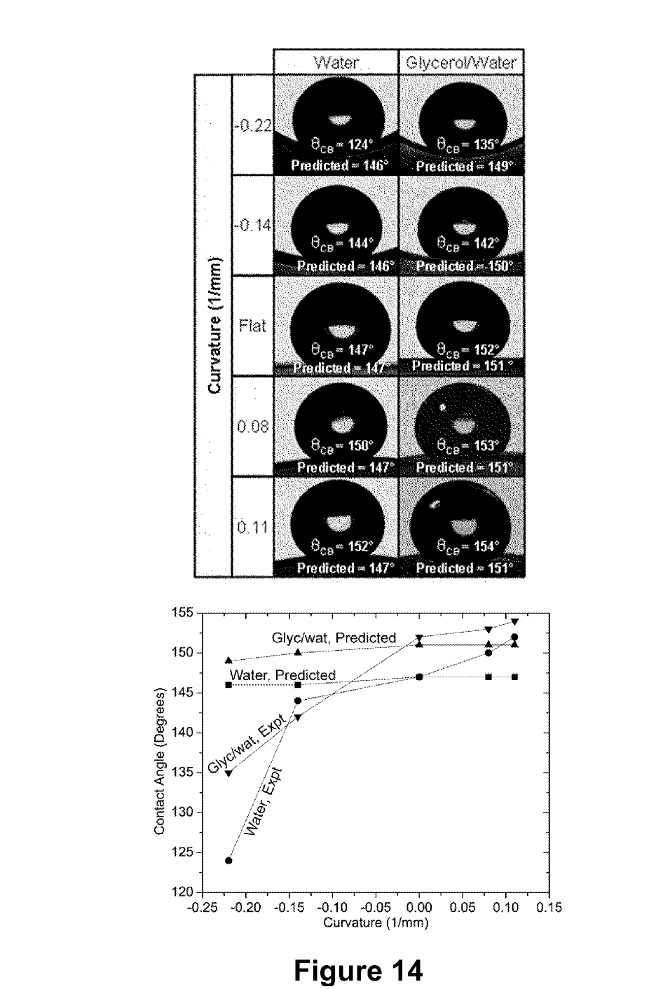

FIG. 14 shows the PDMS is highly flexible and can be flexed into positive or negative curvature while maintaining its superhydrophobicity. It also shows that the contact angle changes as a function of curvature.

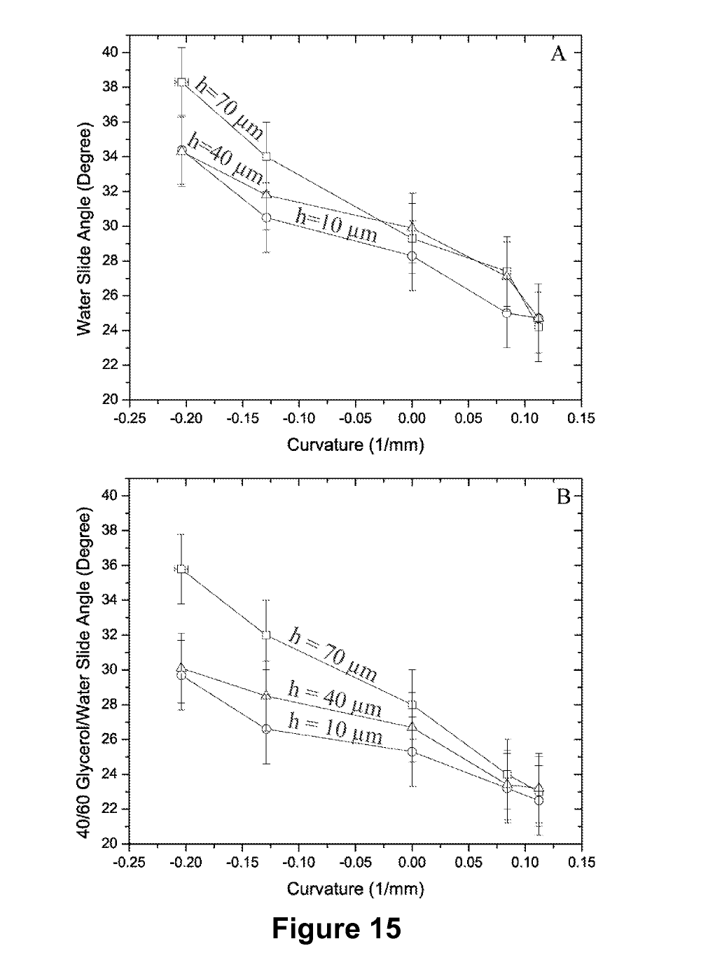

FIG. 15 shows experimental results where the PDMS was flexed to various curvatures. Water or glycerol droplets of volume 10 μl were placed on the flexed PDMS, and the flexed PDMS was tilted to an angle that caused sliding, θ_{SLIDE}. As curvature becomes more positive, θ_{SLIDE} decreases nearly linearly. From FIG. 12, the droplets should remain in the Cassie-Baxter state until the curvature reaches +1.25/mm, well beyond the experimental maximum curvature of 0.11/mm.

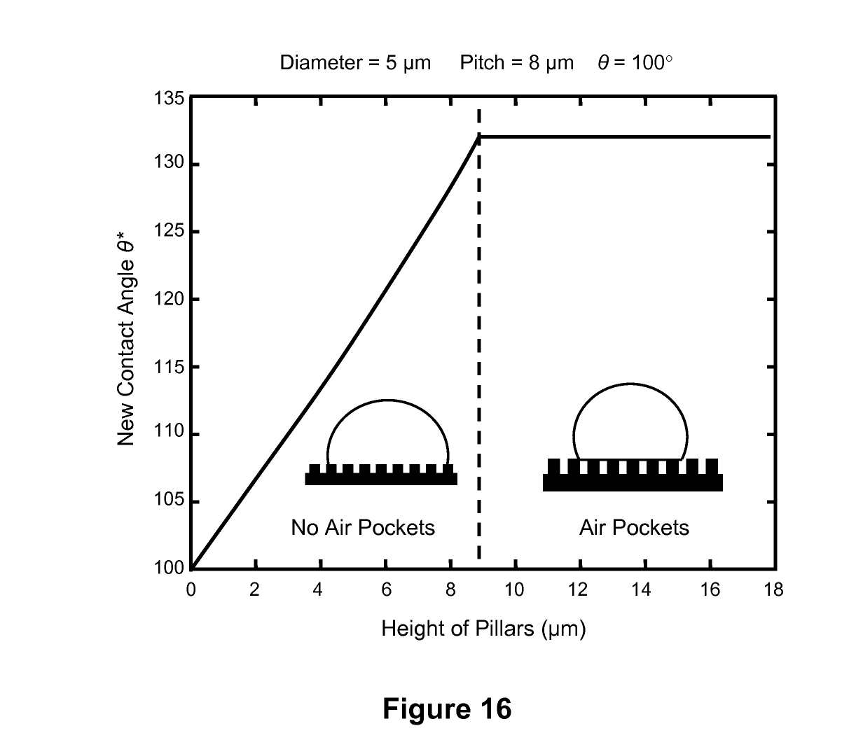

FIG. 16 shows modeling results for pillars 5 μm in diameter with a pitch of 8 μm for a droplet with an original contact angle θ of 100°. The new contact angle θ* increases for the Wenzel State as the height of the pillars increases. As the pillars reach a height between 8 and 9 μm the droplet transitions from the Wenzel state to the Cassie-Baxter state.

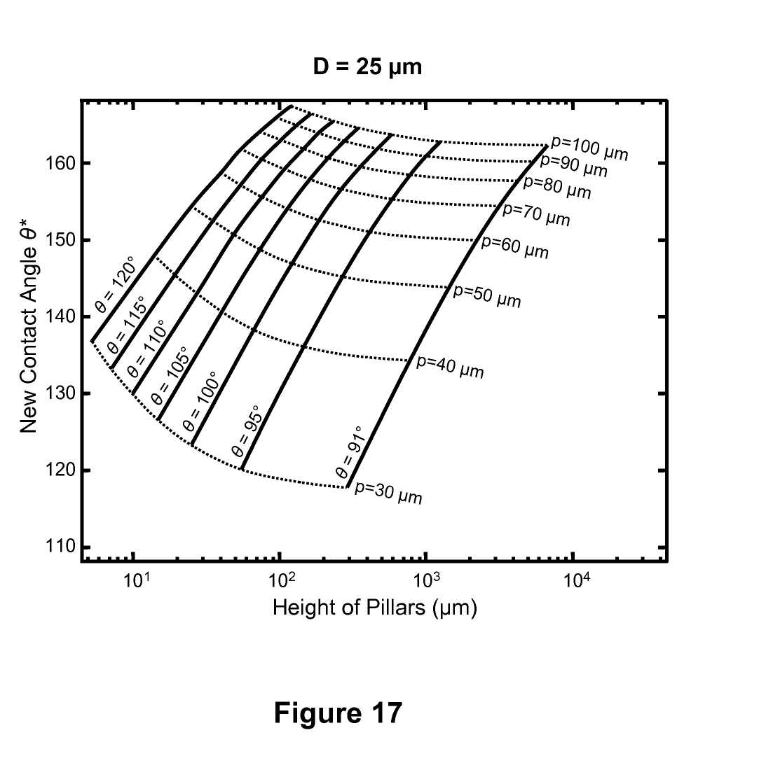

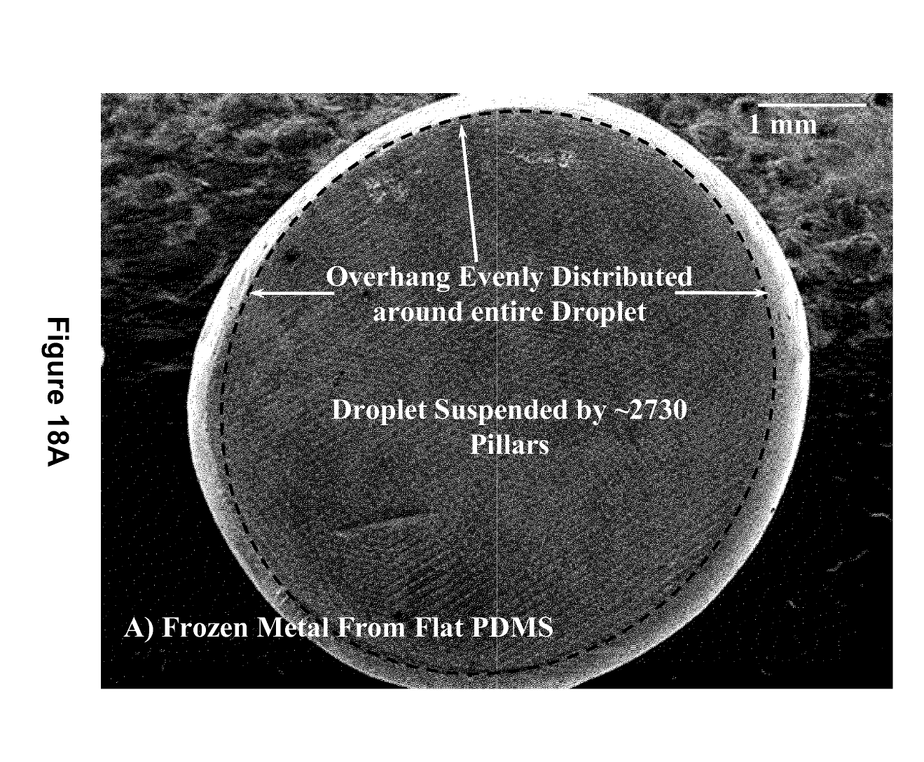

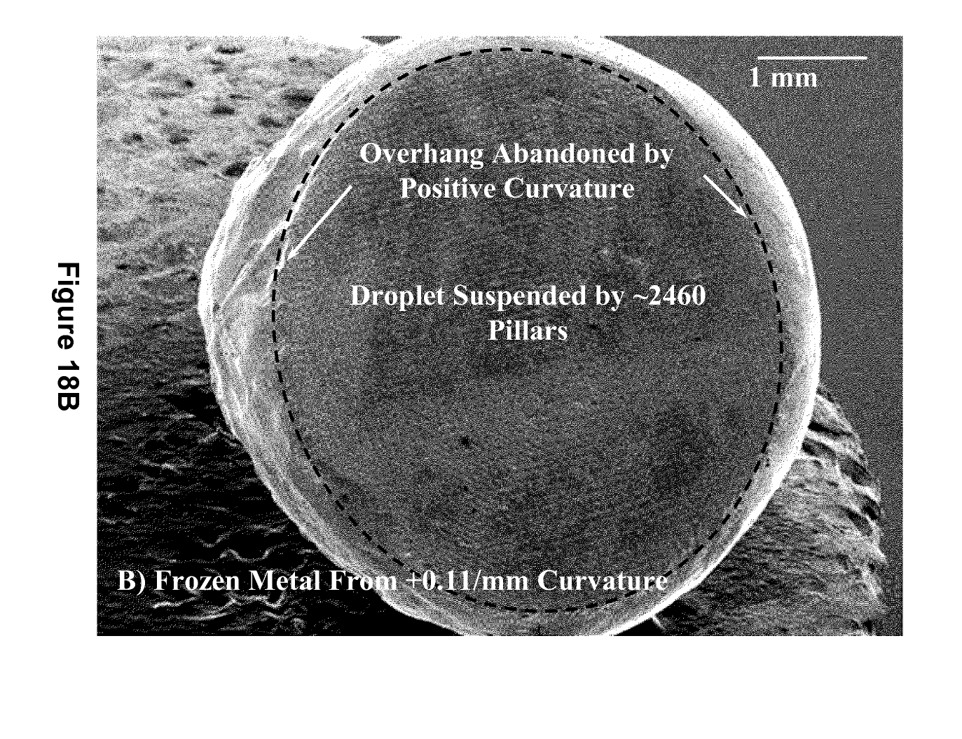

FIG. 17 shows modeling results for the transition between Cassie-Baxter and Wenzel states for micropillars having 25 μm diameters. As the original contact angle θ increases for pillars of a fixed pitch, the critical height for the transition decreases. As the pitch increases for a fixed original contact angle θ, the critical height for the transition increases.

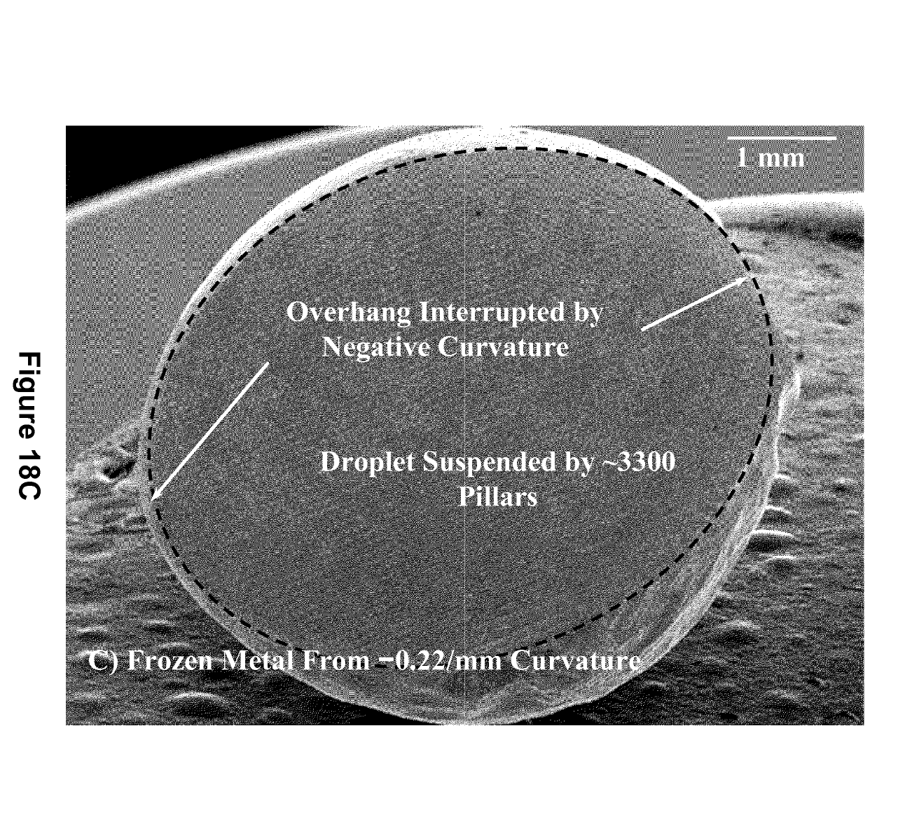

Curvature of the flexed microstructured PDMS alters the number of micropillars that interact with droplets of a given volume. To investigate pillar-droplet interactions, 25 μl of commercially available CerroLow metal with melting point 47° C. was melted, deposited, and allowed to solidify on the 70 μm tall micropillars with no curvature, +0.11/mm curvature, and −0.22/mm curvature. The droplets were then examined under Scanning Electron Microscopy (SEM) for an approximate number of impressions from pillars and curvature-induced geometry. Pillar impressions were counted along the major and minor axes of the elliptical contact line, and the equation for elliptical area gave an approximate count of droplet-pillar interactions. FIG. 18 A) shows the droplet on flat PDMS interacted with approximately 2730 pillars, FIG. 18 B) shows the droplet on the positively curved sample interacted with fewer pillars (2460), and FIG. 18 C) shows the droplet on the negatively curved sample interacted with more pillars (3300).

FIG. 18 A) also reveals that the overhang of the droplet deposited on the flat PDMS is even around the entire droplet while FIG. 18 B) shows the overhang of the droplet deposited on the positive curvature is larger on the sides that were abandoned by PDMS curvature. FIG. 18 C) shows that the natural overhang of the droplet was interrupted by the negative PDMS curvature.

This example shows that the flexure of microstructured polymers affects hydrophobic characteristics. The critical curvature constraints presented here can be used to design microstructure geometries that maintain the Cassie-Baxter state when curved surfaces are covered with microstructured polymers for corrosion resistance or fluid control.

Figure Captions:

FIG. 9. A droplet resting on a solid surface and surrounded by a gas forms a characteristic contact angle θ. If the solid surface is rough, and the liquid is in intimate contact with the solid asperities, the droplet is in the Wenzel state. If the liquid rests on the tops of the asperities, it is in the Cassie-Baxter state.

FIG. 10. Flexing a microstructured surface alters the geometry of the microstructures. When a microstructured surface flexes with positive curvature, the pitch of structures increases, and when it flexes with negative curvature, the pitch decreases. θ_{CB}* is a function of area fraction, φ. φ is a function of pitch, and pitch is a function of curvature. Therefore, θ_{CB}* is a function of curvature. Other hydrophobic properties such as necessary sliding force should also be a function of curvature.

FIG. 11. Pictures showing change in pitch of PDMS pillars as a function of curvature. A) Flat PDMS micropillars with spacing of 24.4 μm. B) Positive Curvature increased Pillar spacing from 24.4 μm to 26.2 μm (predicted=25.5 μm).

C) Negative Curvature decreased Pillar spacing from 24.4 μm to 20.7 μm (predicted=22.1 μm).

FIG. 12. Critical Curvature for high droplet mobility in the Cassie-Baxter state as a function of microstructure pitch and height. θ=112°, thickness=0.7 mm and diameter=25 μm.

FIG. 13. Left: 5 μl glycerol droplet on nonmicrostructured PDMS. Right: 5 μl glycerol droplet on microstructured PDMS, as shown in the inset.

FIG. 14. The microstructured hydrophobic PDMS can be flexed into positive curvature or negative curvature. Contact angle is a function of curvature.

FIG. 15. Experimental Slide Angle as a function of curvature of flexible microstructured PDMS. 10 μl droplets of A) Water and B) a 40/60 wt. mixture of Glycerol/Water. For the film with h=70 μm thickness=1.2 mm, h=40 μm thickness=1.1 mm, and h=10 μm thickness=0.8 mm. The PDMS microstructures were an array of circular pillars 25 μm diameter and 50 μm original pitch.

FIG. 18. Underside of 25 μl Metal droplets solidified on the tops of PDMS pillars. Contact Line outlined in dashed black line. A) Droplet Solidified on Flat PDMS Micropillars. Droplet Overhang was evenly distributed, and the droplet was suspended by 2730 pillars. B) Droplet solidified on Positively Curved PDMS Micropillars. Droplet Overhang was abandoned by the Positive Curvature, and the droplet was suspended by 2460 pillars (fewer pillars than when the droplet was placed on flat PDMS). C) Droplet Solidified on Negatively Curved PDMS Micropillars. Droplet Overhang was interrupted by the negative curvature, and the droplet was suspended by 3300 pillars (more pillars than the droplets suspended by flat or positively curved PDMS pillars).

### REFERENCES

D. Quere, “Non-sticking drops,” Reports on Progress in Physics, vol. 68, pp. 2495-2532, 2005.
A. Shastry, M. J. Case, and K. F. Bohringer, “Engineering surface roughness to manipulate droplets in microfluidic systems,” presented at Micro Electro Mechanical Systems, 2005. MEMS 2005. 18th IEEE International Conference on, 2005.
R. N. Wenzel, “Resistance of Solid Surfaces to Wetting by Water,” Ind. Eng. Chem., vol. 28, pp. 988-994, 1936.
A. B. D. Cassie and S. Baxter, “Wettability of Porous Surfaces,” Trans. Faraday Soc., vol. 40, pp. 546-551, 1944.
Quere, D. and M. Reyssat, Non-adhesive lotus and other hydrophobic materials. Philosophical Transactions of the Royal Society a-Mathematical Physical and Engineering Sciences, 2008. 366(1870): p. 1539-1556.
Zhang, X., et al., Superhydrophobic surfaces: from structural control to functional application. Journal of Materials Chemistry, 2008. 18(6): p. 621-633.
Li, X. M., D. Reinhoudt, and M. Crego-Calama, What do we need for a superhydrophobic surface? A review on the recent progress in the preparation of superhydrophobic surfaces. Chemical Society Reviews, 2007. 36(8): p. 1350-1368.
Li, Y., E. J. Lee, and S. O. Cho, Superhydrophobic coatings on curved surfaces featuring remarkable supporting force. Journal of Physical Chemistry C, 2007. 111(40): p. 14813-14817.
Lee, D. G. and N. Y. Kim, Impact of a superhydrophobic sphere onto water. Langmuir, 2008. 24(1): p. 142-145.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

U.S. provisional patent applications “Methods for Fabricating Microstructures,” filed Feb. 17, 2009 and having Ser. No. 61/153,028; “Flexible Microstructured Superhydrophobic Materials,” filed Feb. 17, 2009 and having Ser. No. 61/153,035; and “Flexible Microstructured Superhydrophobic Materials,” filed Mar. 24, 2009 and having Ser. No. 61/162,762, are herein each incorporated by reference in their entireties to the extent not inconsistent with the present description.

All patents and publications mentioned in the specification are indicative of the levels of skill of those skilled in the art to which the invention pertains.

References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of materials are intended to be exemplary, as it is known that one of ordinary skill in the art can name the same material differently. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A flexible microstructured surface comprising a flexible substrate having a plurality of microfeatures disposed thereon, wherein at least a portion of the substrate is in a bent, flexed, compressed, stretched, expanded and/or strained configuration, wherein the microfeatures have dimensions selected over the range of 10 nm to 1000 μm and wherein a pitch between microfeatures is selected over the range of 10 nm to 1000 μm.

2. The flexible microstructured surface of claim 1, wherein the surface is a superhydrophobic surface and wherein a superhydrophobicity of the surface is maintained when the flexible substrate is deformed.

3.-9. (canceled)

10. The flexible microstructured surface of claim 1, wherein the flexible substrate and the plurality of microfeatures independently comprise materials selected from the group consisting of a polymer, a metal, a composite material, a plant derived industrial material and an animal derived industrial material.

11.-16. (canceled)

17. The flexible microstructured surface of claim 1, wherein the surface is a freestanding film.

18. (canceled)

19. The flexible microstructured surface of claim 1, wherein the microfeatures and the flexible substrate comprise a unitary body.

20.-22. (canceled)

23. The flexible microstructured surface of claim 1, further comprising an adhesive layer on the flexible substrate, wherein the plurality of microfeatures are located on one side of the substrate and the adhesive layer is located on the opposite side of the substrate as the plurality of microfeatures.

24. (canceled)

25. The flexible microstructured surface of claim 1, wherein the plurality of microfeatures are located on both sides of the substrate.

26. The flexible microstructured surface of claim 1, wherein at least a portion of the substrate has a concave curvature or a convex curvature having a radius of curvature selected over the range of 1 mm to 1000 m.

27.-28. (canceled)

29. The flexible microstructured surface of claim 1, wherein at least a portion of the substrate is compressed to a level between 1% and 99% of an original size of the substrate or wherein at least a portion of the substrate is expanded or stretched to a level between 100% and 500% of an original size of the substrate.

30. (canceled)

31. The flexible microstructured surface of claim 1, wherein at least a portion of the substrate has a strain level selected over the range of −99% to 500%.

32. The flexible microstructured surface of claim 1, wherein an aerodynamic resistance of the surface, a hydrodynamic resistance of the surface, a wettability of the surface, a superhydrophobicity of the surface or any combination of these is selectively adjustable by bending, flexing, compressing, stretching, expanding, straining and/or deforming the substrate.

33.-46. (canceled)

47. The flexible microstructured surface of claim 1, further comprising a coating on the plurality of microfeatures, wherein the coating comprises material selected from the group consisting of fluorinated compounds, fluorinated hydrocarbons, fluorinated polymers, silanes, thiols, and any combination of these; and wherein at least a portion of the surface is compressed to a level between 1% and 99% of an original size of the substrate or wherein at least a portion of the surface is expanded or stretched to a level between 100% and 500% of an original size of the substrate.

48.-50. (canceled)

51. The flexible microstructured surface of claim 1, wherein the microstructures are replicated from a lithographically patterned mold.

52. (canceled)

53. A method of controlling the superhydrophobicity of a surface, the method comprising the steps of:
providing a microstructured superhydrophobic surface comprising a flexible substrate having a plurality of microfeatures disposed thereon and wherein the microfeatures have dimensions selected over the range of 10 nm to 1000 μm, wherein a pitch between microfeatures is selected over the range of 10 nm to 1000 μm; and
deforming at least a portion of the microstructured superhydrophobic surface, thereby controlling the superhydrophobicity of the surface.

54.-69. (canceled)

70. A method of making a surface of an object superhydrophobic, the method comprising the steps of:
providing the object;
providing a superhydrophobic surface comprising a flexible substrate having a plurality of microfeatures disposed thereon, wherein the microfeatures have dimensions selected over the range of 10 nm to 1000 μm and wherein a pitch between microfeatures is selected over the range of 10 nm to 1000 μm; and
integrating the superhydrophobic surface into the surface of the object.

71.-82. (canceled)

83. A method of controlling the wettability of a surface, the method comprising the steps of:
providing a surface comprising a flexible substrate having a plurality of microfeatures disposed thereon, wherein the microfeatures have dimensions selected over the range of 10 nm to 1000 μm and wherein a pitch between microfeatures is selected over the range of 10 nm to 1000 μm; and
deforming the flexible substrate, thereby controlling the wettability of the surface.

84.-100. (canceled)
